(19) United States
(12) Patent Application Publication
(10) Pub. No.: US 2004/0167243 A1
(43) Pub. Date: Aug. 26, 2004

(54) Method for producing low molecular weight glycosaminoglycan by ultraviolet ray irradiation

(75) Inventor: Yuniko Shibata, Higashimurayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Seikagaku Corporation, Tokyo (JP)

(21) Appl. No.: 10/781,723

(22) Filed: Feb. 20, 2004

(30) Foreign Application Priority Data
Feb. 20, 2003 (JP) 2003-042790

(51) Int. Cl. C08J 3/28

(52) U.S. Cl. 522/88

(57) ABSTRACT

A method for producing a low molecular weight glycosaminoglycan, which includes irradiating a glycosaminoglycan with an ultraviolet ray. A safe and simple method for producing a low molecular weight glycosaminoglycan is provided.

### BACKGROUND OF THE INVENTION

The present invention relates to a method for producing a low molecular weight glycosaminoglycan. More precisely, the present invention relates to a method for producing a low molecular weight glycosaminoglycan by irradiating a glycosaminoglycan with an ultraviolet ray.

Physiological activities of glycosaminoglycans have hitherto drawn attentions, and for example, hyaluronic acid is used as a component of cosmetics and pharmaceutical preparations. Mainly used hyaluronic acid is a polymer and shows high viscosity, and many pharmaceutical preparations and cosmetics utilizing the viscosity have been developed to date. In recent years, low molecular weight glycosaminoglycans attract attentions, and correlations between their molecular weights (sizes) and activities also attract attentions. For example, Japanese Patent No. 2585216 discloses wound healing effect of low molecular weight hyaluronic acid, and Japanese Patent No. 3333205 discloses use of low molecular weight hyaluronic acid in osteoinduction.

As methods for producing such low molecular weight glycosaminoglycans, i.e., methods for lowering molecular weights of glycosaminoglycans, Japanese Patent Laid-open Publication (Kokai) No. 62-79790 discloses an enzymatic treatment using hyarulonidase, Japanese Patent No. 2587268 discloses acid and alkali treatments, International Patent Publication in Japanese (Kohyo) No. 4-505774 discloses a method of using homogenization, and Japanese Patent Laid-open Publication No. 6-298803 discloses a method of using a physical treatment by shearing. However, these methods have problems such as danger due to use of toxic chemicals and difficulty of removing the used enzymes, acids and alkalis from the product.

Further, although the correlations between molecular weights (molecular sizes) and physiological activities of glycosaminoglycans have attracted attentions as described above, no attempt has been made in conventional methods to control production conditions in view of efficient production of desired low molecular weight glycosaminoglycans, and it is difficult to precisely control the molecular weights.

### SUMMARY OF THE INVENTION

Accordingly, in consideration of the aforementioned problems, an object of the present invention is to provide a safe and simple method for producing a low molecular weight glycosaminoglycan from a glycosaminoglycan. Another object of the present invention is to provide a method for efficiently producing a low molecular weight glycosaminoglycan having a desired molecular weight from a glycosaminoglycan.

Further, another object of the present invention is to decompose and remove contaminants contained in a crude glycosaminoglycan and lower the molecular weight of the glycosaminoglycan at the same time.

The inventors of the present invention assiduously studied in order to achieve the aforementioned objects. As a result, it was found that if glycosaminoglycans were irradiated with an ultraviolet ray, they were decomposed, and thereby their molecular weights were lowered, and further was found that this decomposition of glycosaminoglycans by ultraviolet ray irradiation could be practically utilized as a method for producing low molecular weight glycosaminoglycans. Further, it was also found that when a glycosaminoglycan was irradiated with an ultraviolet ray, the quantity of the irradiated ultraviolet ray was proportional to the reciprocal of the molecular weight of the produced low molecular weight glycosaminoglycan. It was further found that if molecular weight of a glycosaminoglycan was lowered by ultraviolet ray irradiation, contaminants such as proteins and nucleic acids coexisting with the glycosaminoglycan were also decomposed, and thus the low molecular weight glycosaminoglycan was purified easily. The present invention was accomplished on the basis of these findings.

That is, the present invention provides a method for producing a low molecular weight glycosaminoglycan, which comprises irradiating a glycosaminoglycan with an ultraviolet ray.

In a preferred embodiment of the aforementioned method of the present invention, light quantity of the ultraviolet ray to be irradiated is determined from a molecular weight of a desired low molecular weight glycosaminoglycan on the basis of a proportional relationship between the light quantity and reciprocal of molecular weight of a low molecular weight glycosaminoglycan to be produced.

In the aforementioned method of the present invention, the glycosaminoglycan is preferably selected from the group consisting of hyaluronic acid, chondroitin, chondroitin sulfate, dermatan sulfate, heparin, heparan sulfate and keratan sulfate.

Further, in the aforementioned method of the present invention, temperature is preferably maintained at 1 to 37° C. during the irradiation of ultraviolet ray.

Further, in the aforementioned method of the present invention, an ultraviolet ray having a wavelength of 250 to 450 nm is preferably used.

Further, the present invention provides a method for producing a purified low molecular weight glycosaminoglycan, which comprises irradiating a crude glycosaminoglycan containing contaminants with an ultraviolet ray to lower the molecular weight of the glycosaminoglycan and simultaneously decompose and remove the contaminants.

According to the present invention, a novel method for producing a low molecular weight glycosaminoglycan is provided. Since the quantity of ultraviolet ray is found to have a direct proportional relationship with the reciprocal of molecular weight of low molecular weight glycosaminoglycan, a low molecular weight glycosaminoglycan having a desired molecular weight can be prepared by setting the light quantity from the relationship. Therefore, according to the method of the present invention, a low molecular weight glycosaminoglycan can be extremely efficiently produced, and thus the method is extremely useful in industrial applications. Further, according to the present invention, ultraviolet ray absorbing contaminants such as nucleic acids and proteins which may be contained in a raw material glycosaminoglycan can be decomposed, enabling sterilization of the low molecular weight glycosaminoglycans and facilitating purification of the low molecular weight glycosaminoglycans at the same time.

### BRIEF DESCRIPTION OF THE DRAWINGS

FIG. 1 is a graph showing a relationship between light quantity of ultraviolet ray and reciprocal of molecular weight of low molecular weight hyaluronic acid for hyaluronic acid.

FIG. 2 is a graph showing a relationship between light quantity of ultraviolet ray and reciprocal of molecular weight of low molecular weight hyaluronic acid for high molecular weight hyaluronic acid.

FIG. 3 is a graph showing a relationship between light quantity of ultraviolet ray and reciprocal of molecular weight of low molecular weight chondroitin sulfate for chondroitin sulfate.

FIG. 4 is a graph showing a relationship between light quantity of ultraviolet ray and reciprocal of molecular weight of low molecular weight heparan sulfate for heparan sulfate.

FIG. 5 is a graph showing a relationship between light quantity of ultraviolet ray and reciprocal of molecular weight of low molecular weight heparin for heparin.

FIG. 6 shows ultraviolet absorption spectra of a sample containing chondroitin sulfate before and after ultraviolet ray irradiation.

FIG. 7 shows ultraviolet absorption spectra of a sample containing chondroitin sulfate and DNA before and after ultraviolet ray irradiation.

FIG. 8 shows ultraviolet absorption spectra of a sample containing hyaluronic acid before and after ultraviolet ray irradiation.

FIG. 9 shows ultraviolet absorption spectra of a sample containing hyaluronic acid and DNA before and after ultraviolet ray irradiation.

FIG. 10 shows ultraviolet absorption spectra of a sample containing DNA before and after ultraviolet ray irradiation.

FIG. 11 shows ultraviolet absorption spectra of a crude galactosaminoglycan before and after ultraviolet ray irradiation.

FIG. 12 shows structures of unsaturated disaccharides constituting chondroitin sulfate.

FIG. 13 shows structures of unsaturated disaccharides constituting heparin and heparan sulfate.

### DETAILED DESCRIPTION OF THE PREFERRED EMBODIMENTS

In the present invention, the glycosaminoglycan used as an object of the ultraviolet ray irradiation (also referred to “raw material glycosaminoglycan” hereinafter) is a polysaccharide which is constituted by repeating disaccharide units of D-glucosamine or D-galactosamine and D-glucuronic acid, L-iduronic acid or galactose as a basic structure, and in which hydroxyl group, amino group, carboxyl group etc. in the constituting saccharides are sulfated except for hyaluronic acid and chondroitin. Any of such polysaccharides extracted from natural products such as animals, those obtained by culturing microorganisms, those chemically or enzymatically synthesized and so forth may be used.

The glycosaminoglycans include hyaluronic acid, chondroitin sulfates (chondroitin sulfate A, chondroitin sulfate C, chondroitin sulfate D, chondroitin sulfate E), chondroitin, dermatan sulfate, heparin, heparan sulfate and keratan sulfate. Glycosaminoglycans containing D-galactosamine such as chondroitin sulfates, chondroitin and dermatan sulfate are also referred to as galactosaminoglycans.

Further, although the raw material glycosaminoglycan may be in a free form or salt form, it is preferably a usually used pharmacologically acceptable salt, when low molecular weight glycosaminoglycans are used for medical purposes, foods etc. Some examples of the salt of glycosaminoglycan include salts of alkali metals such as sodium and potassium, salts of alkaline earth metals such as calcium and magnesium, salts of amines such as trialkylamine, salts of organic bases such as pyridine and so forth. Although the salt of glycosaminoglycan is not particularly limited, it is more preferably a pharmacologically acceptable alkali metal salt, most preferably a sodium salt.

The molecular weight of the raw material glycosaminoglycan is not particularly limited, and a glycosaminoglycan having a molecular weight larger than the molecular weight of the desired low molecular weight glycosaminoglycan is used. The average molecular weight of the raw material glycosaminoglycan is usually about 5,000 to 20,000,000, and it is usually about 5,000 to 20,000,000, preferably 500,000 to 4,000,000, more preferably 700,000 to 2,500,000 for hyaluronic acid, about 10,000 to 100,000, preferably 10,000 to 80,000 for chondroitin sulfate, about 5,000 to 30,000, preferably 7,000 to 20,000 for heparin, or about 5,000 to 50,000, preferably 10,000 to 30,000 for heparan sulfate.

The molecular weight of glycosaminoglycan is usually represented in terms of an average molecular weight, preferably a weight average molecular weight. This value can be measured by size exclusion gel permeation chromatography-high performance liquid chromatography (GPC-HPLC), multi-angle laser light scattering (MALLS) etc.

Further, a glycosaminoglycan isolated from the aforementioned materials may be subjected to a usual decomposition treatment (for example, enzymatic decomposition, chemical decomposition, heat treatment etc.) to lower the molecular weight to some extent, and then used for the method of the present invention to further lower the lowered molecular weight.

When the aforementioned raw material glycosaminoglycan is irradiated with an ultraviolet ray according to the method of the present invention, the raw material glycosaminoglycan may be in an arbitrary form such as solution, suspension or solid. However, usually glycosaminoglycan in the form of solution is preferably used in view of efficiency in decomposition of glycosaminoglycan by ultraviolet ray irradiation, uniformity of decomposition reaction of glycosaminoglycan and so forth.

When a raw material glycosaminoglycan in the form of a solution is irradiated with an ultraviolet ray, the upper limit of the glycosaminoglycan concentration in the solution is not particularly limited. However, it is about 2% by weight or lower, preferably about 1% by weight or lower, in view of viscosity and handling property of the solution. Although the lower limit of the concentration is not particularly limited either, it is preferably about 0.01% by weight or higher in view of production efficiency of the low molecular weight glycosaminoglycan.

pH of the solution is not also particularly limited, and a solution obtained by dissolving a neutral salt of a glycosaminoglycan can be usually used as it is. However, pH may be adjusted if necessary. For example, when the priority is put on control of the molecular weights of low molecular weight glycosaminoglycans to be within a certain desired range, pH is preferably maintained near neutral. When the priority is put on promotion of the reaction for lowering the molecular weight, pH may be adjusted to be in the acidic range.

The solvent used for the solution is not particularly limited either, and any one of usual solvents which can dissolve glycosaminoglycans such as aqueous solvents (water, phosphate buffer etc.) and organic solvents (dimethylformamide, dimethyl sulfoxide, dioxane etc.) or a water-containing organic solvent comprising any of these organic solvents may be used. However, distilled water for injection and so forth are preferably used to prevent contamination of impurities.

The wavelength of the ultraviolet ray irradiated on the glycosaminoglycan is not particularly limited, and may be in the wavelength range of rays usually referred to as ultraviolet rays, that is, a range of wavelengths shorter than those of visible lights and longer than those of X-rays. However, the range of 250 to 450 nm is preferred in view of efficiency of the glycosaminoglycan decomposition reaction. The light source of the ultraviolet ray is not particularly limited so long as the light source emits an ultraviolet ray, preferably an ultraviolet ray having a wavelength in the aforementioned range of wavelength. Lamps such as metal halide lamp, high pressure mercury lamp, xenon lamp and xenon mercury lamp may be used. The light quantity of the ultraviolet ray is not particularly limited and can be determined depending on the production scale of a desired low molecular weight glycosaminoglycan, type of glycosaminoglycan to be produced and so forth. However, the light quantity is usually 1×10⁴ to 1×10⁶ mJ (millijoules)/cm², preferably 40,000 to 240,000 mJ/cm².

The specific method for the ultraviolet ray irradiation is not particularly limited, and the method of the present invention can be performed by using an arbitrary configuration comprising at least a means for positioning the aforementioned light source of ultraviolet ray and a raw material glycosaminoglycan of which molecular weight is to be lowered so that ultraviolet rays emitted from the light source should be irradiated to such an extent that the lowering of the molecular weight or decomposition of contaminants as the objects of the present invention should be fully achieved.

When a raw material glycosaminoglycan in the form of a solution is irradiated with an ultraviolet ray, for example, a vessel containing the solution needs to transmit the ultraviolet ray. For example, quartz tubes, vessels made of hard glass, plastics such as polyethylene and polypropylene etc. may be used.

In order to perform the method of the present invention, a shielding means for preventing ultraviolet rays from leaking outside, a cooling means for preventing a temperature rise of an object of the irradiation due to the ultraviolet ray irradiation (water cooling system etc.) or the like can be arbitrarily added. Such means per se can be easily selected and used by those skilled in the art. For example, the ultraviolet ray irradiation apparatus described in Japanese Patent Laid-open Publication No. 2000-126589 can be used.

The temperature at which the method of the present invention is performed is not particularly limited so long as it is in the range in which thermal decomposition of glycosaminoglycans does not occur (for example, 1 to 37° C.). However, the irradiation can be usually performed so that temperature should be controlled about at room temperature, specifically about at 10 to 25° C. Further, since the temperature of the reaction system rises when an ultraviolet ray is irradiated according to the method of the present invention, the ultraviolet ray is preferably irradiated with cooling the glycosaminoglycan. The method for cooling glycosaminoglycan is not particularly limited. For example, cooling water can be circulated or cooling air can be blown around a vessel containing the glycosaminoglycan (for example, refer to Japanese Patent Laid-open Publication No. 2000-126589).

As described above, it was found that when a glycosaminoglycan was irradiated with an ultraviolet ray according to the method of the present invention, the quantity of the irradiated ultraviolet ray was proportional to the reciprocal of molecular weight of the produced low molecular weight glycosaminoglycan. That is, it was found that when a raw material glycosaminoglycan was irradiated with an ultraviolet ray according to the method of the present invention to lower the molecular weight, a relationship represented as Y=aX+b (wherein Y is reciprocal of molecular weight of low molecular weight glycosaminoglycan, X is quantity of ultraviolet ray, a and b are constants determined depending on the type of the raw material glycosaminoglycan and its molecular weight) was valid, and the method of the present invention can be performed on the basis of this relationship. Therefore, in the method of the present invention, if the type and the molecular weight of the raw material glycosaminoglycan are determined, a relational formula between the quantity of irradiated ultraviolet ray and the molecular weight of low molecular weight glycosaminoglycan to be produced is determined, and a required quantity of ultraviolet ray to be irradiated can be obtained from the molecular weight of desired low molecular weight glycosaminoglycan using this relational formula. Therefore, a low molecular weight glycosaminoglycan having a desired molecular weight can be extremely efficiently produced.

When the method of the present invention is performed according to the above embodiment, decomposition of a raw material glycosaminoglycan can be performed beforehand with changing the quantity of ultraviolet ray by using a light source to be used in actual production of low molecular weight glycosaminoglycans under the same conditions as in actual production to confirm a direct proportional relationship between the light quantity and the reciprocal of the molecular weight of low molecular weight glycosaminoglycan, and then a light quantity with which the desired molecular weight of the low molecular weight glycosaminoglycan can be selected and used to produce a low molecular weight glycosaminoglycan. That is, the decomposition can be performed with changing the quantity of ultraviolet ray under the same conditions as in actual production as described above so as to obtain molecular weights of obtained low molecular weight glycosaminoglycans and values of a and b in the relational formula in a range in which the aforementioned direct proportional relationship is observed, and a light quantity with which the desired molecular weight of the low molecular weight glycosaminoglycan can be obtained can be calculated on the basis of the obtained relational formula and used to produce a low molecular weight glycosaminoglycan.

When the method of the present invention is performed according to the above embodiment, an ultraviolet ray in a certain quantity must be irradiated to obtain a low molecular weight glycosaminoglycan having a desired molecular weight. The irradiation quantity is determined by output of an ultraviolet ray light source, distance from the light source to an irradiation object and irradiation time, and those skilled in the art can easily obtain a desired irradiation quantity by adjusting these factors. For example, when a raw material glycosaminoglycan existing in the same irradiation area is irradiated with an ultraviolet ray by using the same light source and ultraviolet ray irradiation apparatus, the irradiation quantity is proportional to the irradiation time.

The values of a and b actually obtained as described above are as follows. When the glycosaminoglycan is hyaluronic acid having a molecular weight of 5 to 4000 kDa, a is about 0.5×10⁻⁶ to 10×10⁻⁶, preferably about 1×10⁻⁶ to 5×10⁻⁶, and b is about −0.0005 to 0.001, preferably about −0.001 to 0.0005. When the glycosaminoglycan is heparan sulfate having a molecular weight of 5 to 50 kDa, a is about 0.5×10⁻⁵ to 10×10⁻⁵, preferably about 1×10⁻⁵ to 3×10⁻⁵, and b is about 0.001 to 0.1, preferably about 0.02 to 0.05. When the glycosaminoglycan is heparin having a molecular weight of 5 to 20 kDa, a is about 0.1×10⁻⁵ to 10×10⁻⁵, preferably about 0.5×10⁻⁵ to 2×10⁻⁵, and b is about 0.001 to 0.2, preferably about 0.05 to 0.1. When the glycosaminoglycan is chondroitin sulfate having a molecular weight of 10 to 100 kDa, a is about 1×10⁻⁶ to 20×10⁻⁶, preferably about 5×10⁻⁶ to 10×10⁻⁶, and b is about 0.001 to 0.01, preferably about 0.01 to 0.05.

The aforementioned molecular weights are all weight average molecular weights measured by the aforementioned method. Further, the aforementioned specific values of a and b are used when the direct proportional relationship is represented as a line, and the relational formula determined on the basis of these values is used in a range in which both X and Y are positive.

The molecular weight of low molecular weight glycosaminoglycan obtained by irradiating an ultraviolet ray as described above is not particularly limited. However, it is usually about 200 to 1,000,000, preferably about 4,000 to 400,000, further preferably about 4,000 to 20,000, in terms of average molecular weight.

Many kinds of glycosaminoglycans have sulfate groups, and it is known that sulfate group content and positions at which the sulfate groups bind considerably affect physiological activities of the glycosaminoglycans. In conventional methods for lowering molecular weight, these sulfate groups may be eliminated at the same time as the molecular weight is lowered. However, if the molecular weight of sulfated glycosaminoglycan is lowered by the method of the present invention, the molecular weight can be lowered substantially without eliminating sulfate groups. Further, when the molecular weight is lowered by the method of the present invention, decomposition of constituting saccharides does not occur, but glycosidic bonds between the constituting saccharides are cleaved as shown in the examples described later. This confirms that the produced low molecular weight glycosaminoglycan does not suffer from any change affecting physiological activities except for changes associated with the lowering of the molecular weight.

Further, when a raw material glycosaminoglycan containing small amounts of proteins or nucleic acids as contaminants was irradiated with an ultraviolet ray, and proteins or nucleic acids were analyzed and quantified before and after the irradiation, it was found that the amounts of these substances were markedly decreased after the ultraviolet ray irradiation. Therefore, when molecular weight of a glycosaminoglycan is lowered by the method of the present invention, ultraviolet ray-absorbing contaminants such as proteins, nucleic acids, pigments and other ultraviolet ray absorbing substances can be decomposed at the same time as the lowering of the molecular weight.

By purifying a glycosaminoglycan of which molecular weight is lowered by the method of the present invention using conventionally used purification methods such as anion exchange chromatography, gel filtration chromatography, ethanol fractionation, dialysis or ultrafiltration, decomposition products of contaminants can be removed, and a purified low molecular weight glycosaminoglycan having a particular molecular weight with a narrower average molecular weight distribution can be produced.

Furthermore, the objective glycosaminoglycan can also be sterilized by the ultraviolet ray irradiation.

### EXAMPLES

The present invention will be explained more specifically with reference to the following examples. However, the scope of the present invention is not limited to these examples.

### Example 1

### Lowering of Molecular Weights of Various Glycosaminoglycans by Ultraviolet Ray Irradiation

Aqueous solutions of the following glycosaminoglycan samples were prepared at a concentration of 1% by weight by using distilled water for injection.

1. Hyaluronic acid (HA), average molecular weight: 899.1 kDa, derived from crest, produced by Seikagaku Corporation

2. High molecular weight hyaluronic acid (HA high), average molecular weight: 2580 kDa, derived from crest, produced by Seikagaku Corporation

3. Chondroitin sulfate (CS), average molecular weight: 66.72 kDa, derived from shark cartilage, produced by Seikagaku Corporation

4. Heparan sulfate (HS), average molecular weight: 27.8 kDa, derived from bovine kidney, produced by Seikagaku Corporation

5. Heparin (Hep), average molecular weight: 11.1 kDa, derived from bovine small intestine, produced by SPL

Each glycosaminoglycan aqueous solution was introduced into a quartz tube (1 cm in diameter×15 cm, 2 mm in thickness) and sealed with a silicon plug.

The ultraviolet ray irradiation apparatus used was a UV irradiation apparatus (the apparatus described in Japanese Patent Laid-open Publication No. 2000-126589) which had a 6000 W metal halide lamp (model type SMX-7000H) and designed so that an irradiation object should be irradiated with an ultraviolet ray (UV) emitted from the metal halide lamp at a distance of 70 cm from the object, and light quantity could be measured (HMW-680, Oak Seisakusho). The lamp was cooled by an indirect cooling method in which cooling water was circulated in double quartz tubes surrounding the lamp. Further, in order to prevent temperature rise of a sample caused by the light source, cold air generated by a cooling type refrigerator provided in the apparatus was circulated in the UV irradiation section and blown onto the irradiation object. By this cooling, the temperature in the UV irradiation section was maintained at 14 to 16° C. After the irradiation of UV in quantities shown in Tables 1 to 5 mentioned below, the samples were collected and analyzed by size exclusion gel-permeation chromatography-high performance liquid chromatography (GPC-HPLC-1 or -2 under the following conditions) to obtain the reciprocal of the average molecular weight in each sample at each time point. The results are also shown in Tables 1 to 5. Conditions of HPLC were as follows.

GPC-HPLC-1

Column 1: column obtained by connecting three of columns, TSKgel G2500 PW_{XL} (Tosoh Corporation), TSKgel G3000 PW_{XL} (Tosoh Corporation) and TSKgel G4000 PW_{XL} (Tosoh Corporation) (optimum molecular weight range: about 3 to 350 kDa)

Column 2: column obtained by connecting three of columns, TSKgel G6000 PW_{XL} (Tosoh Corporation), TSKgel G5000 PW_{XL} (Tosoh Corporation) and TSKgel G4000 PW_{XL} (Tosoh Corporation) (optimum molecular weight range: about 40 to 2500 kDa)

Solvent: 0.2 M NaCl

Flow rate: 0.6 mL/min

Column temperature: 40° C.

High-performance liquid chromatography (HPLC) apparatus set

Pump: dual pump DP-8020

Column oven: CO-8020

Automatic sampler: AS-8020

Degasser: Online Degasser SD-8023

Detector: differential refractometer RI-8020 (Tosoh Corporation) (40° C.)

GPC-HPLC-2

Column: column obtained by connecting two of TSKgel Super AW6000 (Tosoh Corporation) (optimum molecular weight range: about 3 to 2500 kDa)

A suitable size of column was used depending on the molecular weight of the sample.

Solvent: 0.2 M NaCl

Flow rate: 0.3 mL/min

Column temperature: 40° C.

High-performance liquid chromatography (HPLC) apparatus set

Pump: dual pump DP-8020

Column oven: CO-8020

Automatic sampler: AS-8020

Segasser: Online Degasser SD-8023

Detector: differential refractometer RI-8020 (Tosoh Corporation) (40° C.)

TABLE 1
HA

| | Average | Reciprocal of molecular |
|---|---|---|
| Light quantity | molecular | weight of low molecular |
| (mj/cm²) | weight Mw (kDa) | weight HA (1/Mw) |
| 0 | 899.1 | 0.001 |
| 40000 | 593.6 | 0.002 |
| 60000 | 509.8 | 0.002 |
| 120000 | 251.2 | 0.004 |
| 180000 | 167.9 | 0.006 |
| 240000 | 113.5 | 0.009 |

TABLE 2
HA high

| | | Reciprocal of molecular |
|---|---|---|
| Light quantity | Average molecular | weight of low molecular |
| (mj/cm²) | weight Mw (kDa) | weight HA (1/Mw) |
| 0 | 2580.0 | 0.000 |
| 40000 | 1940.0 | 0.001 |
| 60000 | 1473.0 | 0.001 |
| 120000 | 442.0 | 0.002 |
| 180000 | 206.0 | 0.005 |
| 240000 | 204.0 | 0.005 |

TABLE 3
CS

| | | Reciprocal of molecular |
|---|---|---|
| Light quantity | Average molecular | weight of low molecular |
| (mj/cm²) | weight Mw (kDa) | weight CS (1/Mw) |
| 0 | 66.72 | 0.015 |
| 40000 | 58.4 | 0.017 |
| 60000 | 54.8 | 0.018 |
| 120000 | 46.1 | 0.022 |
| 180000 | 38.9 | 0.026 |
| 240000 | 28.6 | 0.035 |

TABLE 4
HS

| | | Reciprocal of molecular |
|---|---|---|
| Light quantity | Average molecular | weight of low molecular |
| (mj/cm²) | weight Mw (kDa) | weight HS (1/Mw) |
| 0 | 27.8 | 0.036 |
| 40000 | 24.4 | 0.041 |
| 60000 | 23.2 | 0.043 |
| 120000 | 19.9 | 0.050 |
| 180000 | 16.9 | 0.059 |
| 240000 | 13.9 | 0.072 |

TABLE 5
Hep

| | | Reciprocal of molecular |
|---|---|---|
| Light quantity | Average molecular | weight of low molecular |
| (mj/cm²) | weight Mw (kDa) | weight Hep (1/Mw) |
| 0 | 11.1 | 0.009 |
| 40000 | 10.7 | 0.0093 |
| 60000 | 10.6 | 0.094 |
| 120000 | 10.1 | 0.099 |
| 180000 | 9.3 | 0.108 |
| 240000 | 8.9 | 0.113 |

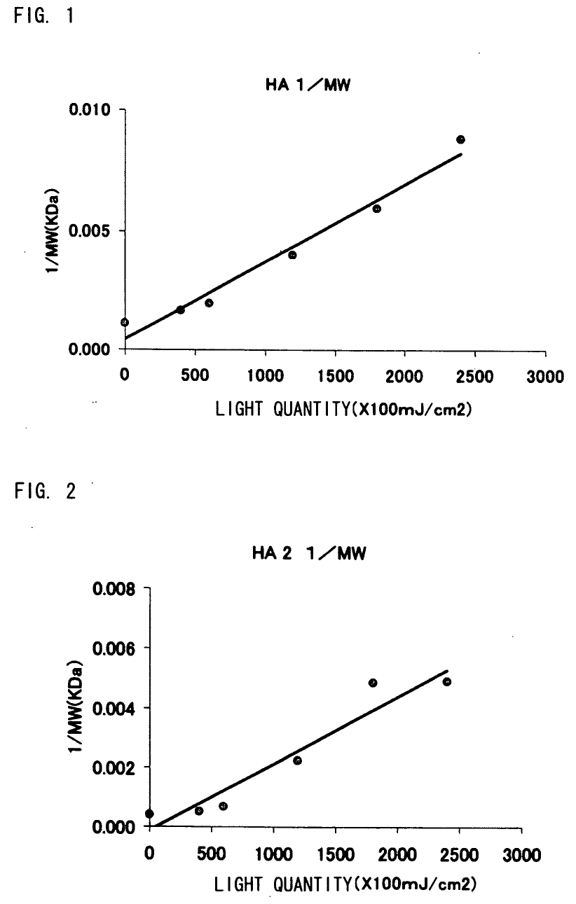

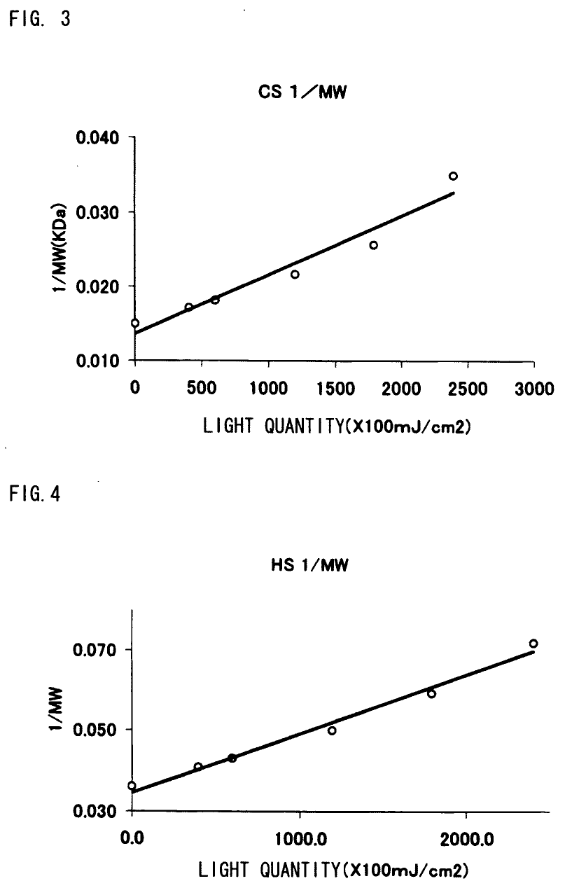

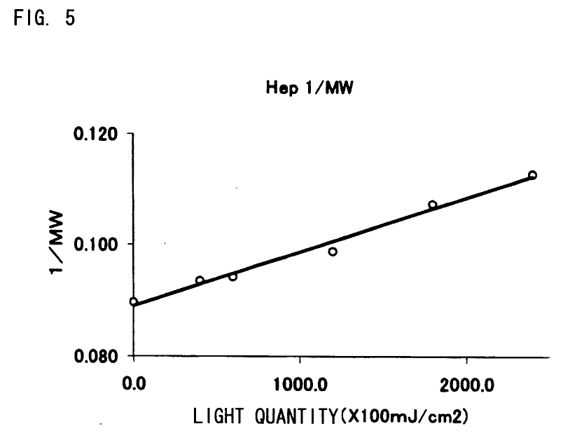

FIGS. 1 to 5 show the plots of the reciprocals of the molecular weights of low molecular weight glycosaminoglycans (weight average molecular weights, the same shall apply hereinafter) against the quantities of ultraviolet rays represented in Tables 1 to 5.

As shown in FIGS. 1 to 5, a direct proportional relationship is observed between the reciprocals of the molecular weights of the produced low molecular weight glycosaminoglycans and the quantities of the irradiated ultraviolet rays. If the type of a raw material glycosaminoglycan and its molecular weight are determined, a relational formula between the quantity of the ultraviolet ray and the molecular weight of low molecular weight glycosaminoglycan to be obtained is determined. Since the quantity of ultraviolet ray is determined on the basis of the direct proportional relationship with the reciprocal of molecular weight of low molecular weight glycosaminoglycan to be obtained as described above, a low molecular weight glycosaminoglycan having a desired molecular weight can be prepared by setting the light quantity on the basis of the relationship.

Further, when uronic acid in each sample was quantified by the carbazole-sulfuric acid method, and the reduced viscosity was determined by using a capillary viscometer, no changes in the quantified values due to the irradiation was observed in the quantification by the carbazole-sulfuric acid method, and the reduced viscosity obtained by using a capillary viscometer was found to have decreased with an increase in the quantity of the ultraviolet ray. Therefore, it was also demonstrated that lowering of the molecular weight was progressed by the ultraviolet ray irradiation without causing structural changes of sugar chains themselves in such a degree that the aforementioned quantification should be affected.

Further, when the digestion rate of each raw material glycosaminoglycan with a glycosaminoglycan decomposing enzyme (chondroitinase ABC or mixed enzymes of heparitinase I, II and heparinase) was examined in each sample, the raw material glycosaminoglycan was digested at a rate of 100% in all samples. Thus, it was also demonstrated that the lowering of the molecular weight was advanced without causing structural changes of sugar chains themselves in such a degree that the enzymatic digestion should be affected.

### Example 2

### Removal of Contaminants by Lowering of Molecular Weight of Glycosaminoglycan by Ultraviolet Ray Irradiation

1. Samples

The following sample solutions were prepared.

(i) Chondroitin sulfate (CS), concentration: 0.97 mg/mL, average molecular weight: 66.72 kDa, derived from shark cartilage, produced by Seikagaku Corporation

(ii) Hyaluronic acid (HA), concentration: 0.82 mg/mL, average molecular weight: 899.1 kDa, derived from crest, produced by Seikagaku Corporation

(iii) DNA (calf thymus DNA), concentration: 0.19 mg/mL, produced by SIGMA

(iv) Bovine serum albumin (BSA), concentration: 1.13 mg/mL, produced by Seikagaku Corporation

2. Experimental Method

1) Preparation of Samples

Distilled water, the aforementioned DNA solution or BSA solution was added in a volume of 1 mL to 19 mL of each of the aforementioned CS solution and HA solution to prepare 6 types of samples. That is, samples containing only 0.92 mg/mL of CS or 0.78 mg/mL of HA and solutions containing HA or CS at the same concentration and DNA or BSA were prepared. Further, a solution containing 1 mL of DNA or BSA solution in 19 ml of distilled water was prepared.

2) Ultraviolet Ray Irradiation Method

Each solution was introduced into a quartz tube similar to that used in Example 1, placed in a clean bench and irradiated with ultraviolet rays by using two of attached UV lamps (15 W) for continuous 14 days. The distance between the lamps and the sample was about 30 cm. A fan was operated in the clean bench to prevent temperature rise. The temperature was measured every day and maintained at about 22.3 to 22.5° C.

3) Analysis Method

(i) Before and after the ultraviolet ray irradiation, each sample was analyzed by size exclusion gel permeation chromatography-high performance liquid chromatography (GPC-HPLC) to confirm molecular weights of the sample HA and CS and the decomposition products. HPLC conditions were as follows.

Column: column obtained by connecting three of columns, TSKgel G2500 PW_{XL} (Tosoh Corporation), TSKgel G3000 PW_{XL} (Tosoh Corporation) and TSKgel G4000 PW_{XL} (Tosoh Corporation) (optimum molecular weight range: about 3 to 350 kDa)

Solvent: 0.2 M NaCl

Flow rate: 0.6 mL/min

Column temperature: 40° C.

High-performance liquid chromatography (HPLC) apparatus set

Pump: dual pump DP-8020

Column oven: CO-8020

Automatic sampler: AS-8020

Degasser: Online Degasser SD-8023

Detector: differential refractometer RI-8020 and ultraviolet and visible light detector UV-8020 (210 nm)

(ii) Each sample added with DNA was analyzed by the ethylene bromide method before and after the ultraviolet ray irradiation to confirm the presence of DNA.

(iii) Each sample added with BSA was analyzed by using BioRad Protein Assay (protein quantification kit produced by BioRad) before and after the ultraviolet ray irradiation to confirm the presence of BSA.

(iv) Ultraviolet absorption spectra (200 to 800 nm) of each sample were measured before and after the ultraviolet ray irradiation.

(v) Uronic acid in each sample after the irradiation was quantified by the carbazole-sulfuric acid method.

4) Results

(i) As a result of the analysis by HPLC, in the samples containing CS, CS having an average molecular weight of about 60,000 was detected before the ultraviolet ray irradiation, whereas low molecular weight CS decomposition products having a molecular weight of 5,000 or less were detected after the irradiation. In the samples containing HA, HA having an average molecular weight of about 890,000 was detected before the ultraviolet ray irradiation, whereas decomposition products in sizes of oligosaccharide to monosaccharide were detected after the irradiation.

(ii) As a result of the analysis by the ethylene bromide method, about 70 to 90 μg/mL of DNA was detected in all the samples added with DNA before the ultraviolet ray irradiation, whereas no DNA was detected in any sample after the irradiation (below the detection limit).

(iii) As a result of the measurement of the protein content using BioRad Protein Assay, about 0.9 mg/mL of BSA was detected in all the samples added with BSA before the ultraviolet ray irradiation, whereas the BSA content decreased to about 1/10 to 1/20 in all the samples after the irradiation.

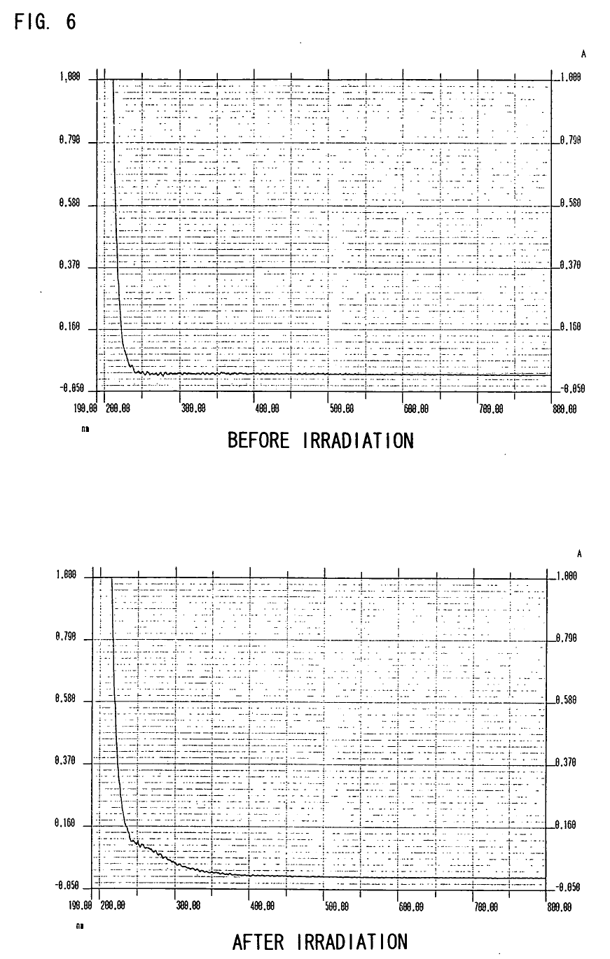

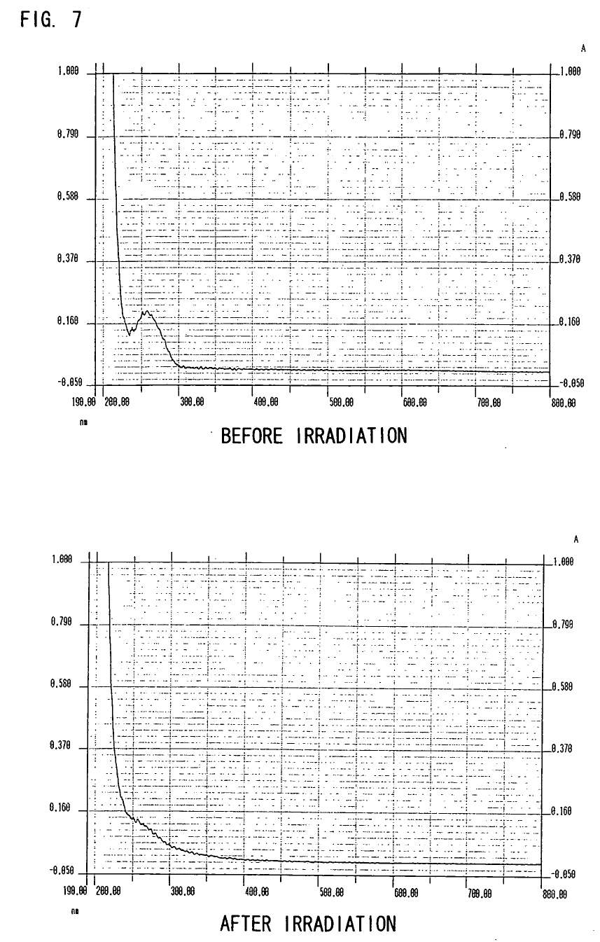

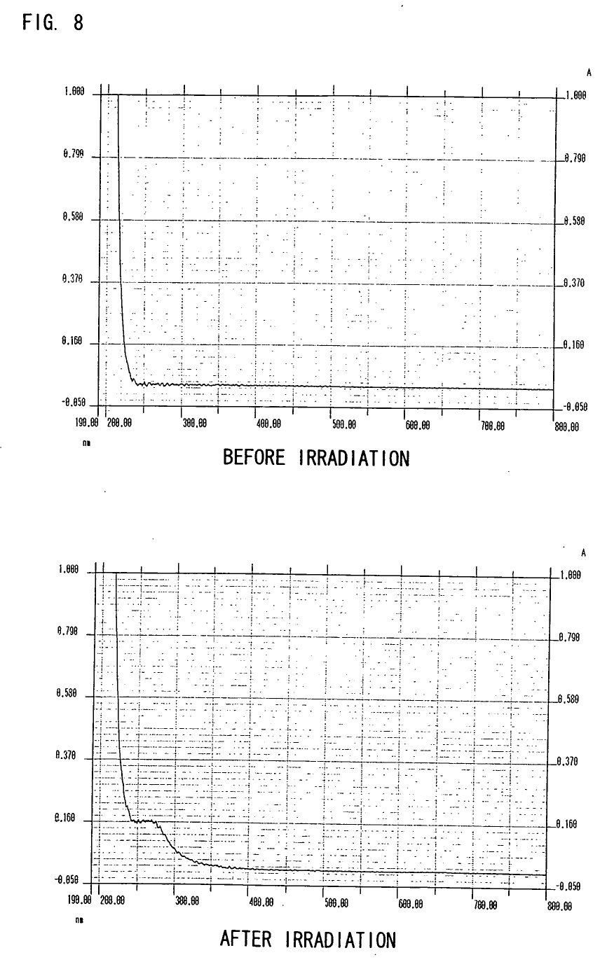

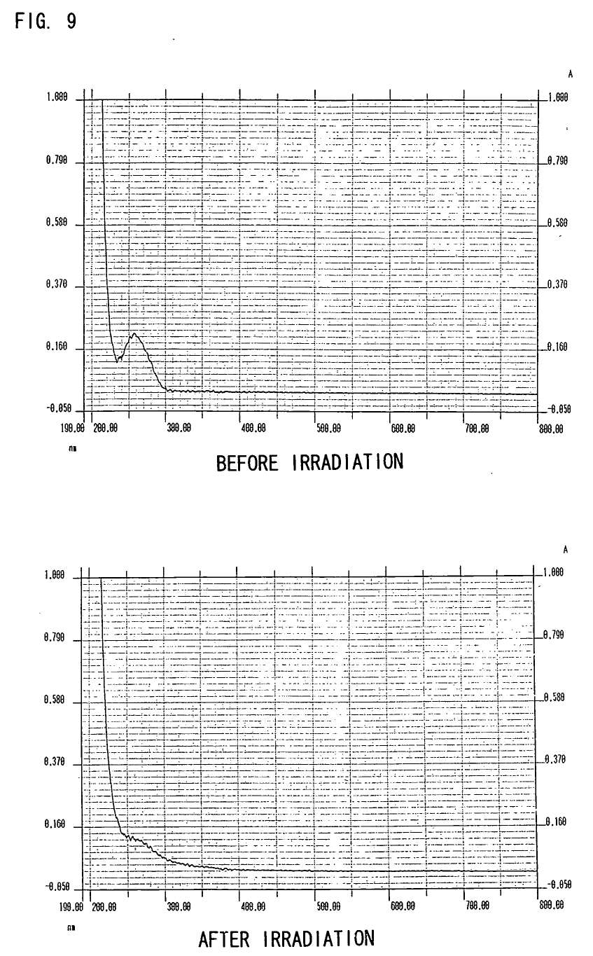

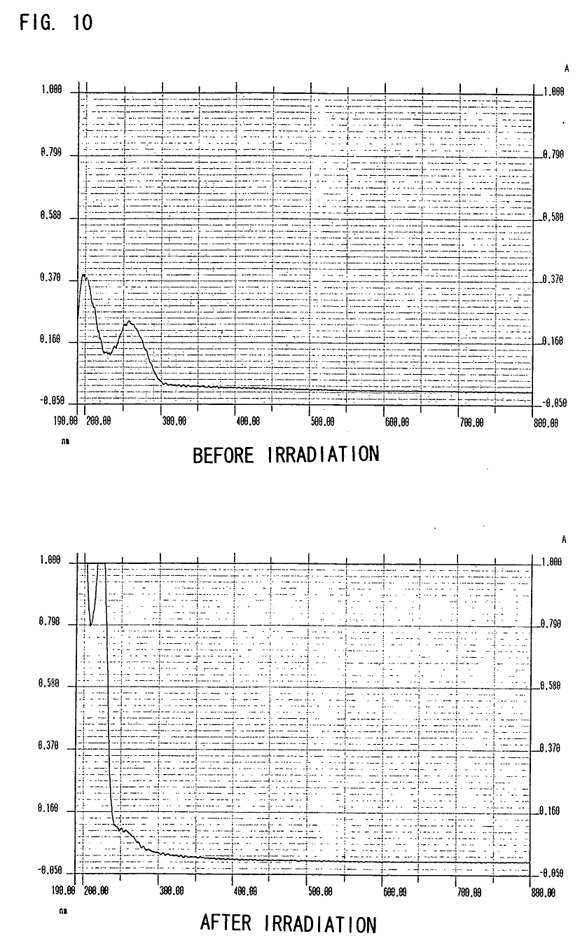

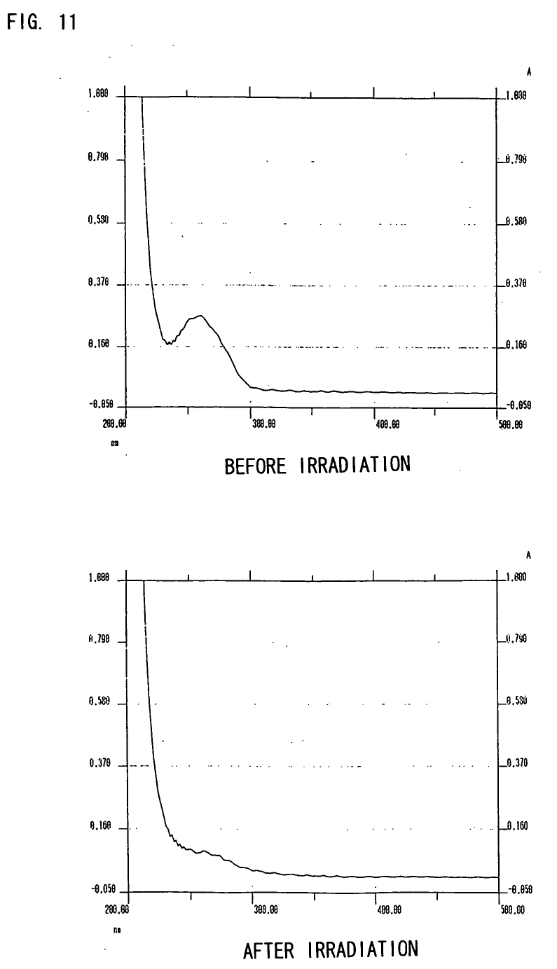

(iv) The ultraviolet absorption spectra (200 to 800 nm) of each sample before and after the ultraviolet ray irradiation are shown in FIGS. 6 to 10. An absorption spectrum having a peak top at 260 nm was obtained for all the samples added with DNA before the ultraviolet ray irradiation. However, this peak decreased or disappeared after the irradiation. In the samples containing only HA or CS, a peak that had not been observed before the irradiation was observed after the irradiation. This is considered to be attributable to fragments of HA or CS decomposed by the irradiation.

(v) When uronic acid was quantified in each sample by the carbazole-sulfuric acid method after the irradiation, coloration was observed in all the samples, and thus it was confirmed that the uronic acid structure was maintained, that is, decomposition of constituting saccharides themselves did not occur after the lowering of molecular weight.

From the aforementioned results, it was confirmed that the molecular weight of the glycosaminoglycan was lowered by ultraviolet ray irradiation while the glycosaminoglycan structure was maintained irrespective of the presence or absence of DNA or proteins, and that coexisting DNA and proteins were decomposed by the ultraviolet ray irradiation at the same as the lowering of molecular weight of glycosaminoglycan.

Therefore, if the molecular weight of glycosaminoglycan is lowered by the method of the present invention, coexisting nucleic acids, proteins etc. are decomposed at the same time. Thus, even if a raw material glycosaminoglycan contains such contaminants, the contaminants are also decomposed in fractions containing the obtained low molecular weight glycosaminoglycan, and hence the obtained low molecular weight glycosaminoglycan is purified easily.

### Example 3

### Removal of Contaminants in Crude Galactosaminoglycan by Ultraviolet Ray Irradiation

1. Preparation of Crest Crude Product

Crest in an amount of 1,500 kg was added with 4000 L of water, minced, boiled, cooled and then added with a protease (Pronase, Kaken Pharmaceutical Co., Ltd.) to perform hydrolysis overnight. The hydrolysis solution was added with 32 L of benzalkonium chloride solution and then filtered through diatomaceous earth. The filtration supernatant was discarded to obtain 180 kg of diatomaceous earth. This diatomaceous earth in an amount of 500 g was added with 800 mL of 2 M sodium chloride solution, heated to 40° C., stirred for 1.5 hours and filtered. The filtrate was added with 2-fold volume of ethanol, and the obtained precipitates were dissolved in 0.5% sodium carbonate. The solution was adjusted to pH 10, added with 1 g of alkaline protease and allowed to react overnight at 45° C. The reaction mixture was filtered, and the filtrate was made into 1 N sodium hydroxide solution, allowed to react at 40° C. for 1 hour, then neutralized and filtered. The obtained filtrate was added with ethanol at a concentration of 42%, and the obtained precipitates were dried to obtain 3.2 g of powder.

The aforementioned powder in an amount of 500 mg was dissolved in 100 mL of 5% calcium acetate solution and added with ethanol at a concentration of 15% with regard to the solution with stirring on an ice bath. The produced precipitates were removed by centrifugation, and ethanol was further added to the supernatant at a concentration of 26% with regard to the supernatant with stirring. The obtained precipitates were collected by centrifugation and dried to obtain 340 mg of a crude galactosaminoglycan mainly consisting of dermatan sulfate.

2. Experimental Method

1) Preparation of Samples

The aforementioned crude product in an amount of 56 mg was dissolved in 5 mL of distilled water.

2) Ultraviolet Ray Irradiation Method

The aforementioned solution was introduced into a quartz tube (1 cm in diameter×15 cm, 2 mm in thickness) and sealed with a silicon plug. As an ultraviolet ray light source, a 3000 W metal halide lamp (model: UVL-3000M2) was used. As an ultraviolet ray irradiation apparatus, the aforementioned ultraviolet ray light source was disposed at the center position of a stainless case along the longitudinal direction of the case. In order to prevent temperature rise of samples caused by the light source, one cooling water inlet and one cooling water discharge port were further provided in the stainless case. The case was sealed with a stainless lid and cooled with running water during the ultraviolet ray irradiation. By the water cooling in such a manner, the sample temperature was maintained at 19 to 22° C. during the ultraviolet ray irradiation. The aforementioned quartz tube enclosing the sample was placed on the bottom of the case in parallel to the light source lamp and maintained at a distance of 10 cm from the light source during the irradiation. Irradiation was performed for 3 hours under the aforementioned conditions.

3) Analysis Method

(i) Each sample was analyzed by GPC-HPLC in the same manner as in Example 2 before and after the ultraviolet ray irradiation to confirm lowering of the molecular weight of galactosaminoglycans. However, as a detector, only the differential refractometer RI-8020 was used.

(ii) Ultraviolet absorption spectra of each sample were measured for the range of 200 to 500 nm before and after the ultraviolet ray irradiation.

4) Results

As a result of the analysis by HPLC, lowering of the molecular weights of galactosaminoglycans by ultraviolet ray irradiation could be confirmed. Further, as a result of the measurement of the ultraviolet absorption spectra, it was confirmed that the absorption spectrum having a peak top at 260 nm, which had been confirmed before the irradiation, disappeared after the irradiation, that is, nucleic acids were decomposed.

The results are shown in FIG. 11.

From the aforementioned results, it was revealed that the method of the present invention was effective for removal of contaminating substances showing ultraviolet absorption such as nucleic acids, proteins and pigments during the preparation of low molecular weight glycosaminoglycans.

### Example 4

### Disaccharide Composition Analysis of Glycosaminoglycan

Various sulfated glycosaminoglycans shown in Tables 6 and 7 were irradiated with ultraviolet rays in the same manner as in Example 1 to lower their molecular weights, and the disaccharide compositions of the glycosaminoglycans of various sizes were analyzed by a usual method before and after the irradiation to confirm elimination of sulfate groups bound to the constituting saccharides. The analysis was performed according to the method described in “Shin Seikagaku Jikken Koza (Lecture of Biochemical Experiments, New Edition)”, 3, Saccharides II, pp.49-62.

A) Chondroitin Sulfate Before and After Irradiation

Chondroitin sulfate was completely digested to unsaturated disaccharides with chondroitinase ABC (Seikagaku Corporation), and composition of the disaccharides was analyzed by HPLC. The details will be described below.

1) Digestion with Chondroitinase ABC

In a volume of 20 μL of 1% chondroitin sulfate solution was added with 10 μL of Buffer A (0.01 mol/L sodium acetate, 0.05 mol/L Tris-HCl, pH 7.5) and then added with 0.5 U/10 μL of chondroitinase ABC. The digestion reaction was performed at 37° C. for 2 hours and then terminated by heating on a boiling water bath for 1 minute. This decomposition product and the substrate (CS) before the digestion were subjected to GPC-HPLC to confirm complete decomposition of the chondroitin sulfate. Further, this decomposition product was analyzed by HPLC under the following conditions to determine the disaccharide composition.

2) Analysis by HPLC

The chondroitinase ABC digestion solution was analyzed by using the following HPLC. As a column, YMC-Pack PA-120-S5 ion exchange column (φ 2.6×250 mm, YMC) was used. At a flow rate of 1.5 mL/min, 0.8 mol/L of sodium hydrogenphosphate was flown as a linear concentration gradient of from 2 to 100% over 60 minutes. On the basis of the elution positions obtained with Unsaturated Chondro-Disaccharide Kit (Seikagaku Corporation), various unsaturated disaccharides eluted during the aforementioned elution were identified by measuring their absorption at 232 nm, and the disaccharide composition ratio was obtained on the basis of the total area of peaks identified as unsaturated disaccharides, which total area was taken as 100%. The results are shown in Table 6.

TABLE 6

| | ΔDi- | | | | | | | Chase ABC |
|---|---|---|---|---|---|---|---|---|
| | 0S | 6S | 4S | diSD | diSE | triS | Total | digestion rate (%) |
| CS (raw material) | 1.8 | 71.2 | 18.3 | 7.8 | 0.8 | 0.0 | 100 | 100 |
| (Mw 66000) | | | | | | | | |
| CS (decomposition product) | 1.9 | 71.4 | 18.2 | 7.7 | 0.8 | 0.0 | 100 | 100 |
| (Mw 59400) | | | | | | | | |
| CS (decomposition product) | 1.9 | 71.1 | 18.4 | 7.8 | 0.8 | 0.0 | 100 | 100 |
| (Mw 54800) | | | | | | | | |
| CS (decomposition product) | 2.2 | 70.9 | 18.2 | 8.0 | 0.7 | 0.0 | 100 | 100 |
| (Mw 38900) | | | | | | | | |
| CS (decomposition product) | 2.5 | 70.6 | 18.2 | 8.0 | 0.7 | 0.0 | 100 | 100 |
| (Mw 28500) | | | | | | | | |

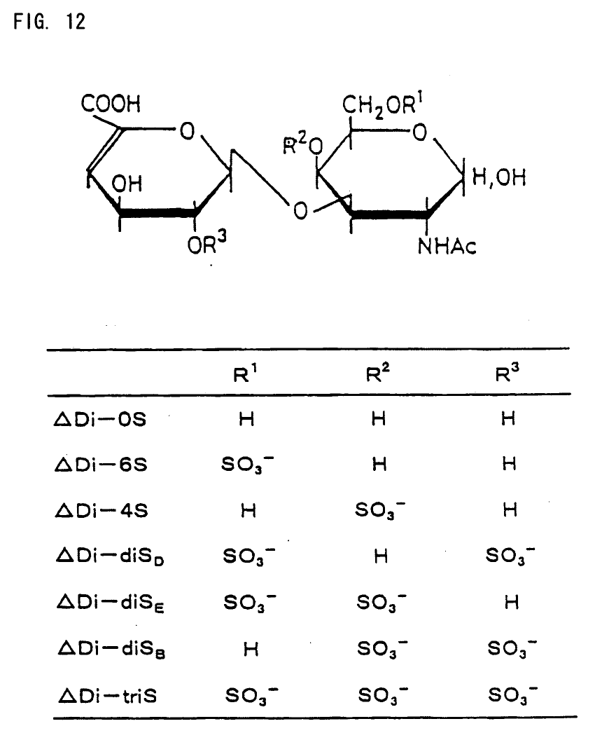

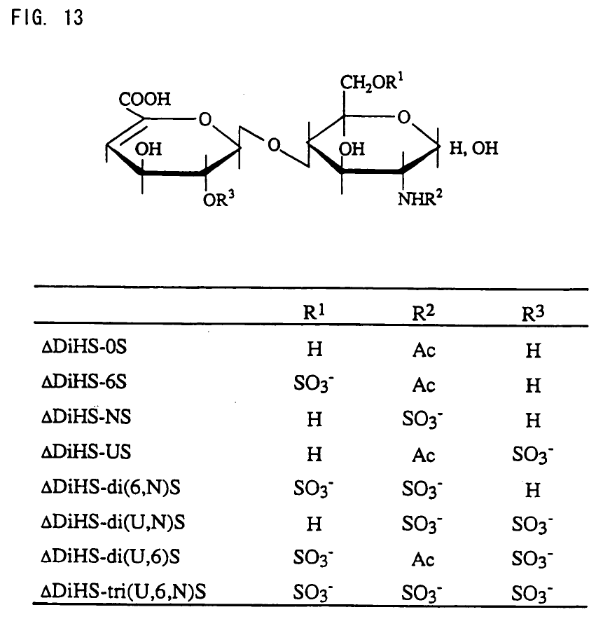

The abbreviations of unsaturated disaccharides mentioned in the upper column in the table are notations according to Analytical Biochemistry, 177, 327-332 (1989). Specific structures of the unsaturated disaccharides are shown in FIG. 12.

B) Heparin (Hep) and Heparan Sulfate (HS)

1) Digestion with Heparin/Heparan Sulfate Decomposing Enzyme

Before and after the irradiation, 20 uL of 1% heparin or heparan sulfate solution was added with 10 ul of 20 mM sodium acetate (pH 7.0) containing 2 mM calcium acetate and then 10 uL of a mixed enzyme solution (EMII) of 30 mU of heparitinase I, 20 mU of heparitinase II and 50 mU of heparinase and allowed to react at 37° C. for 2 hours. The reaction mixture was heated on a boiling water bath for 1 minute to terminate the reaction. This decomposition product and the substrate (Hep or HS) before the digestion were subjected to GPC-HPLC, and it was confirmed that they had been completely decomposed. Further, the decomposition product was analyzed by HPLC under the following conditions to determine the disaccharide composition.

2) Analysis by HPLC

The digestion solution obtained with the mixed enzyme of heparitinases I, II and heparinase was analyzed by the following HPLC. As a column, DIONEX CarboPac PA-1 ion exchange column (φ 4×250 mm, DIONEX) was used. At a flow rate of 1 mL/min, 3 M lithium chloride solution was flown as a linear concentration gradient of from 0 to 75% over 30 minutes. On the basis of the elution positions obtained with Unsaturated Heparan/Heparin Disaccharide Kit (Seikagaku Corporation), various unsaturated disaccharides eluted during the elution were identified on the basis of absorption at 232 nm. The disaccharide composition ratio was obtained on the basis of on the total area of the peak areas identified as unsaturated disaccharides, which total area was taken as 100%. The results are shown in Table 7.

TABLE 7

| | ΔDi- | | | | | | | | EMII |
|---|---|---|---|---|---|---|---|---|---|
| | 0S | NS | 6S | UA2S | di(6,N)S | di(U,N)S | tri(U,N,6)S | Total | digestion rate (%) |
| HS (raw material) | 48.1 | 21.5 | 14.3 | 1.3 | 6.1 | 5.1 | 3.6 | 100 | 100 |
| (Mw 27800) | | | | | | | | | |
| HS (decomposition product) | 47.6 | 21.4 | 14.1 | 1.3 | 7.0 | 5.0 | 3.6 | 100 | 100 |
| (Mw 27200) | | | | | | | | | |
| HS (decomposition product) | 48.0 | 21.6 | 14.2 | 1.3 | 6.2 | 5.0 | 3.6 | 100 | 100 |
| (Mw 24400) | | | | | | | | | |
| HS (decomposition product) | 48.4 | 20.6 | 14.5 | 1.5 | 6.4 | 4.9 | 3.7 | 100 | 100 |
| (Mw 1300) | | | | | | | | | |
| Hep (raw material) | 3.8 | 2.0 | 4.4 | 1.6 | 13.8 | 6.5 | 68.0 | 100 | 100 |
| (Mw 11100) | | | | | | | | | |
| Hep (decomposition product) | 2.8 | 2.1 | 4.3 | 1.5 | 13.8 | 6.0 | 69.4 | 100 | 100 |
| (Mw 10200) | | | | | | | | | |
| Hep (decomposition product) | 3.2 | 1.9 | 4.3 | 1.6 | 13.6 | 6.1 | 69.3 | 100 | 100 |
| (Mw 9300) | | | | | | | | | |
| Hep (decomposition product) | 3.4 | 2.0 | 4.3 | 1.6 | 13.5 | 6.1 | 69.1 | 100 | 100 |
| (Mw 8800) | | | | | | | | | |

The abbreviations of unsaturated disaccharides mentioned in the upper column in the table are notations according to Analytical Biochemistry, 177, 327-332 (1989). Specific structures of the unsaturated disaccharide isomers are shown in FIG. 13.

From the above results, it was demonstrated that the disaccharide compositions of the raw material glycosaminoglycans were maintained in the low molecular weight glycosaminoglycans obtained by the ultraviolet ray irradiation, and the disaccharide compositions were not substantially affected by the ultraviolet ray irradiation.

What is claimed is:

1. A method for producing a low molecular weight glycosaminoglycan, which comprises irradiating a glycosaminoglycan with an ultraviolet ray.

2. The method according to claim 1, wherein light quantity of the ultraviolet ray is determined from molecular weight of a desired low molecular weight glycosaminoglycan on the basis of a direct proportional relationship between quantity of irradiated ultraviolet ray and reciprocal of molecular weight of low molecular weight glycosaminoglycan to be produced.

3. The method according to claim 1, wherein the glycosaminoglycan is selected from the group consisting of hyaluronic acid, chondroitin, chondroitin sulfate, dermatan sulfate, heparin, heparan sulfate and keratan sulfate.

4. The method according to claim 1, wherein temperature is maintained at 1 to 37° C. during ultraviolet ray irradiation.

5. The method according to claim 1, wherein the ultraviolet ray to be irradiated has a wavelength of 250 to 450 nm.

6. A method for producing a purified low molecular weight glycosaminoglycan, which comprises irradiating a crude glycosaminoglycan containing contaminants with an ultraviolet ray to lower the molecular weight of the glycosaminoglycan and simultaneously decompose and remove the contaminants.
